(19) United States
(12) Patent Application Publication
(10) Pub. No.: US 2019/0039165 A1
(43) Pub. Date: Feb. 7, 2019

(54) METHOD FOR WELDING AUSTENITIC STAINLESS STEEL SHEETS

(71) Applicant: NISSHIN STEEL CO., LTD., Tokyo (JP)

(72) Inventors: Yoshitomo FUJIMURA, Yamaguchi (JP); Kazunari IMAKAWA, Yamaguchi (JP); Osamu YAMAMOTO, Yamaguchi (JP); Manabu OKU, Yamaguchi (JP); Isamu HAYAKAWA, Aichi (JP); Hiroaki SHICHI, Aichi (JP); Yoshihide NARUSE, Aichi (JP)

(73) Assignee: NISSHIN STEEL CO., LTD., Tokyo (JP)

(21) Appl. No.: 15/757,718

(22) PCT Filed: Aug. 30, 2016
(86) PCT No.: PCT/JP2016/075349

§ 371 Date: Mar. 6, 2018

(30) Foreign Application Priority Data
Sep. 8, 2015 (JP) 2015-176734

(51) Int. Cl. B23K 9/23; B23K 9/02; B23K 31/02; C22C 38/54; C22C 38/50; C22C 38/48; C22C 38/46; C22C 38/44; C22C 38/42; C22C 38/06; C22C 38/04; C22C 38/00; C22C 38/34

(52) U.S. Cl. CPC B23K 9/23; B23K 2103/05; B23K 31/02; C22C 38/54; C22C 38/50; C22C 38/48; C22C 38/46; C22C 38/44; C22C 38/42; C22C 38/06; C22C 38/04; C22C 38/002; C22C 38/001; C22C 38/34; B23K 9/02

(57) ABSTRACT

A method for welding austenitic stainless steel sheets, in which welding defects do not easily occur. Austenitic stainless steel sheets each with a sheet thickness of 0.6 to 1.0 mm, which each contain, in terms of mass %, 0.08% or less of C, 1.5 to 4.0% of Si, 2.0% or less of Mn, 0.04% or less of P, 0.01% or less of S, 16.0 to 22.0% of Cr, 10.0 to 14.0% of Ni, and 0.08% or less of N, and contain at least one of Nb and Ti in an amount of 1.0% or less in total, with the rest including Fe and inevitable impurities, are overlapped and the overlapped portion is welded by arc welding. In addition, the back side of a deposited portion is cooled from 1200° C. to 900° C. at a cooling rate of 110° C./sec or higher.

### CROSS-REFERENCE TO RELATED APPLICATIONS

This is a U.S. national phase application under 35 U.S.C. § 371 of International Patent Application No. PCT/JP2016/075349, filed Aug. 30, 2016, and claims benefit of priority to Japanese Patent Application No. 2015-176734 filed Sep. 8, 2015. The entire contents of these applications are hereby incorporated by reference.

### FIELD OF TECHNOLOGY

The present invention relates to a method for welding austenitic stainless steel sheets, which method welds overlapped austenitic stainless steel sheets.

### BACKGROUND

In recent years exhaust gases have been strictly regulated from a standpoint of environmental issues, and there is a tendency to raise the temperature of exhaust gases to further improve fuel efficiency and engine combustion efficiency.

In order that the capacity for purifying exhaust gases at the time of engine starting will become more efficient, a dual wall exhaust manifold including an inner pipe and an outer pipe and having a void between the inner pipe and outer pipe can be loaded (see Japanese Laid-open Patent Publication No. 11-93654, Japanese Laid-open Patent Publication No. 8-334017 and Japanese Laid-open Patent Publication No. 8-334018).

In this type of dual wall exhaust manifold, the inner pipe tends to be thinner than a pipe in a single wall exhaust manifold.

Therefore, ferritic stainless steel, which has a small coefficient of thermal expansion, is usually used for a single wall exhaust manifold; however, austenitic stainless steel, which has better workability than ferritic stainless steel, is used for the inner pipe in a dual wall exhaust manifold.

### SUMMARY

The inner pipe and outer pipe in a dual wall exhaust manifold are often produced by overlapping press-molded pipe parts and carrying out fillet weld by arc welding such as MIG welding.

However, since the inner pipe in a dual wall exhaust manifold is thinner than a pipe in a common single wall exhaust manifold, it is very difficult to control heat input in welding and there is a problem in that welding defects such as hot cracking and ductility-dip cracking easily occur particularly in a weld joint region.

The present invention was made in view of such points, and an object thereof is to provide a method for welding austenitic stainless steel sheets, in which welding defects do not easily occur.

The method for welding austenitic stainless steel sheets according to claim 1 is a method in which austenitic stainless steel sheets each with a sheet thickness of 0.6 mm to 1.0 mm, which each contain C: 0.08 mass % or less, Si: 1.5 mass % to 4.0 mass %, Mn: 2.0 mass % or less, P: 0.04 mass % or less, S: 0.01 mass % or less, Cr: 16.0 mass % to 22.0 mass %, Ni: 10.0 mass % to 14.0 mass %, and N: 0.08 mass % or less, and contain at least one of Nb and Ti in an amount of 1.0 mass % or less in total, with the rest including Fe and inevitable impurities, are overlapped and the overlapped portion is welded by arc welding, and the back side of a deposited portion, which is a site with the highest temperature at the time of welding on the back side of the welded surface, is cooled from 1200° C. to 900° C. at a cooling rate of 110° C./sec or higher.

The method for welding austenitic stainless steel sheets according to claim 2 is the method for welding austenitic stainless steel sheets according to claim 1, wherein the austenitic stainless steel sheet contains at least one of Al, Zr and V in an amount of 1.0 mass % or less in total.

The method for welding austenitic stainless steel sheets according to claim 3 is a method for welding austenitic stainless steel sheets according to claim 1 or 2, wherein the austenitic stainless steel sheet contains at least one of Mo and Cu in an amount of 4.0 mass % or less in total.

The method for welding austenitic stainless steel sheets according to claim 4 is a method for welding austenitic stainless steel sheets according to any one of claims 1 to 3, wherein the austenitic stainless steel sheet contains B in an amount of 0.01 mass % or less.

The method for welding austenitic stainless steel sheets according to claim 5 is a method for welding austenitic stainless steel sheets according to any one of claims 1 to 4, wherein the length of an overlap space in a weld joint region when welding the overlapped portion is 2.5 mm or more.

According to the present invention, the back side of a deposited portion, which is a site with the highest temperature at the time of welding on the back side of the welded surface, is cooled from 1200° C. to 900° C. at a cooling rate of 110° C./sec or higher, and thus heat generated at the time of welding can be transferred and the occurrence of welding defects can be prevented.

### BRIEF DESCRIPTION OF DRAWINGS

FIG. 1 is a cross-section view schematically showing a weld joint region according to an embodiment of the present invention.

FIG. 2 is a cross-section view schematically showing a deformed example of the weld joint region described above.

FIG. 3 is a graph showing a relationship between a cooling rate and a crack occurrence rate in Examples and Comparative Examples.

### DETAILED DESCRIPTION

The structure of an embodiment of the present invention will now be described in detail.

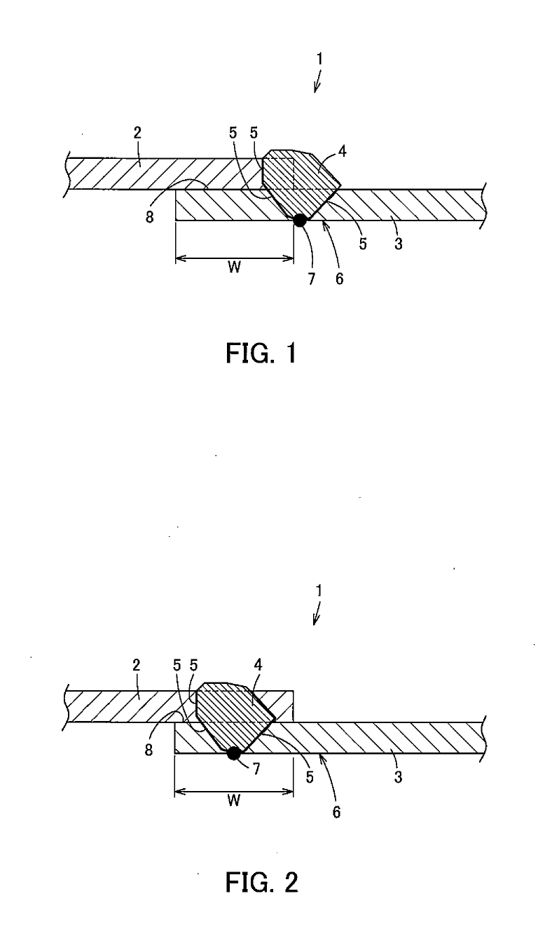

A dual wall exhaust manifold includes an outer pipe, and an inner pipe arranged via a gap on the inside of the outer pipe. The outer pipe and inner pipe are each subjected to MIG welding in a weld joint region 1 shown in FIG. 1 using a weld rod such as a weld wire, and are fixed with a hollow heat-insulting layer arranged between the outer pipe and the inner pipe.

In addition, by such welding, the weld joint region 1 forms a structure having a pipe base material portion 2, a pipe base material portion 3, a deposited portion 4 in which the pipe base material portions 2, 3 are deposited, and a bond portion 5 which is a boundary between the pipe base material portions 2, 3 and the deposited portion 4. It should be noted that the dashed line in FIG. 1 shows a state in which the pipe base material portions 2, 3 before deposition are set.

The inner pipe is thinner than the outer pipe and it is very difficult to control heat input in welding, and thus it is important not to easily cause welding defects such as hot cracking and ductility-dip cracking.

Therefore, an austenitic stainless steel sheet with a sheet thickness of 0.6 mm to 1.0 mm, which has better workability than ferritic stainless steel, is used for the inner pipe. In addition, the components of austenitic stainless steel for the inner pipe are specifically designed as described below.

The base material components for the inner pipe (austenitic stainless steel) contain 0.08 mass % or less of C (carbon), 1.5 mass % to 4.0 mass % of Si (silicon), 2.0 mass % or less of Mn (manganese), 0.04 mass % or less of P (phosphorus), 0.01 mass % or less of S (sulfur), 16.0 mass % to 22.0 mass % of Cr (chromium), 10.0 mass % to 14.0 mass % of Ni (nickel), and 0.08 mass % or less of N (nitrogen), and contain at least one of Nb (niobium) and Ti (titanium) in an amount of 1.0 mass % or less in total, and the rest includes Fe (iron) and inevitable impurities.

It should be noted that austenitic stainless steel may have a structure containing at least one of Al (aluminum), Zr (zirconium) and V (vanadium) in an amount of 1.0 mass % or less in total as needed.

In addition, austenitic stainless steel may have a structure containing at least one of Mo (molybdenum) and Cu (copper) in an amount of 4.0 mass % or less in total as needed.

Furthermore, austenitic stainless steel may have a structure containing B (boron) in an amount of 0.01 mass % or less as needed.

C is effective in improving the high-temperature strength of austenitic stainless steel; however, when C is excessively contained, above 0.08 mass %, there is a possibility that Cr carbide will be formed during use to deteriorate toughness and moreover there is a possibility that the amount of Cr solid solution effective in improving high-temperature oxidation resistance will be reduced. Therefore, the C content is 0.08 mass % or less (there are not cases where C is not contained).

Si is very effective in improving high temperature oxidation characteristics, and when Si is contained in a base material in an amount of 1.5 mass % or more, a Si concentrated film is formed on the inside of Cr oxide at a temperature range of 850 to 900° C. to improve scale peeling resistance. However, when Si is excessively contained in a base material, above 4.0 mass %, there is a possibility that σ embrittlement sensitivity will increase to cause σ embrittlement during use. Therefore, the Si content is 1.5 mass % or more and 4.0 mass % or less, preferably 3.0 mass % or more and 4.0 mass % or less.

Mn is an austenite phase stabilizing element and mainly shows the action of adjusting the balance of the δ phase; however, when Mn is excessively contained, above 2.0 mass %, there is a possibility that high-temperature oxidation resistance will be reduced. Therefore, the Mn content is 2.0 mass % or less (there are not cases where Mn is not contained).

When P is contained in an amount of above 0.04 mass %, there is a possibility that the hot workability of austenitic stainless steel will be reduced, and thus it is preferred that the content be reduced as much as possible. Therefore, the P content is 0.04 mass % or less.

When S is contained in an amount of above 0.01 mass %, there is a possibility that the hot workability of austenitic stainless steel will be reduced like P, and thus it is preferred that the content be reduced as much as possible. Therefore, the S content is 0.01 mass % or less.

Cr suppresses scale formation at high temperature and is an element effective in improving high temperature oxidation characteristics, and it is required to contain 16.0 mass % or more of Cr to show such action. However, when Cr is excessively contained, above 22.0 mass %, there is a possibility that σ embrittlement will be caused. Therefore, the Cr content is 16.0 mass % or more and 22.0 mass % or less.

Ni is an austenite phase stabilizing element and is mainly contained to adjust the balance of the δ phase; however, it is required to contain 10.0 mass % or more of Ni to show such action. However, when Ni is excessively contained, an increase in costs will be caused and thus the upper limit of the Ni content is 14.0 mass %. Therefore, the Ni content is 10.0 mass % or more and 14.0 mass % or less.

N is an element to improve high-temperature strength by solid solution strengthening; however, when N is excessively contained, above 0.08 mass %, there is a possibility that toughness will be reduced due to the formation of Cr nitride. Therefore, the N content is 0.08 mass % or less (there are not cases where N is not contained).

Nb and Ti are elements which are bound to C and N to improve high-temperature strength; however, when Nb and Ti are excessively contained, there is a possibility that a low melting point will be caused. Therefore, when Nb and Ti are contained to improve high-temperature strength, at least one of Nb and Ti is contained in an amount of 1.0 mass % or less in total.

Al is a potent ferrite forming element and is effective for stabilization of the δ phase. In addition, Zr and V are elements which are bound to C and N to improve high-temperature strength. However, when Al, Zr and V are excessively contained, there is a possibility that a low melting point will be caused. Therefore, when Al, Zr and V are contained to improve high-temperature strength, it is preferred that at least one of Al, Zr and V be contained in an amount of 1.0 mass % or less in total.

Mo is a ferrite forming element and is effective in improving high-temperature strength; however, when Mo is excessively contained, there is a possibility that σ embrittlement will be caused and toughness will be reduced. In addition, Cu is an austenite forming element and is useful in improving high-temperature strength; however, when Cu is excessively contained, there is possibility that high-temperature oxidation resistance will be reduced. Therefore, when Mo and Cu are contained to improve high-temperature strength, it is preferred that at least one of Mo and Cu be contained in an amount of 4.0 mass % or less in total.

B is effective in improving the grain boundary strength of a weld joint region to improve heat resistance; however, when B is contained in a large amount, there is a possibility that hot workability will be reduced. Therefore, when B is contained to improve heat resistance, it is preferred that the B content be 0.01 mass % or less.

A welding method for welding the above austenitic stainless steel sheet will now be described.

When welding inner pipes, MIG welding is carried out with parts of the inner pipes overlapped each other.

It should be noted that the welding conditions of MIG welding, the type of core wire and the flow rate of shielding gas for example can be suitably set and selected. Inert gases such as argon and nitrogen are used as types of shielding gas, and it is preferred that the oxygen concentration in an inert gas be 5.0 vol % or less from a standpoint of the prevention of oxide incorporation in a weld region.

In order to prevent the occurrence of welding defects such as welding hot cracking in MIG welding, heat transfer is important in which heat generated at the time of welding is promptly transferred to another site by cooling after welding.

In order to effectively prevent the occurrence of welding defects by promptly transferring heat after welding, it is effective to restrict a cooling rate for the back side of the welded surface 6 opposite to the welded surface in a weld joint region 1.

Specifically, the back side of a deposited portion 7, which is a site with the highest temperature on the back side of the welded surface 6, is cooled from 1200° C. to 900° C. at a cooling rate of 110° C./sec or higher after welding.

As a method for increasing the cooling rate after welding and setting the cooling rate to 110° C./sec or higher, for example a method in which heat input itself in welding is reduced within a range acceptable in terms of product properties, a method in which a back plate of Cu and the like is put on the back side of the welded surface 6 to promote heat transfer, a method in which the flow rate of back-shielding gas is adjusted, a method in which shielding gas is directly sprayed to the back side of the welded surface 6 and the like can be suitably carried out.

Here, a site where heat is least likely to transfer at the time of welding is an overlapped portion 8 where steel sheets are overlapped each other. Therefore, a structure in which the length of an overlap space W in the overlapped portion 8 is 2.5 mm or more is preferred to enlarge the volume of the overlapped portion 8 and promote thermal conduction (heat transfer), and the length of the overlap space W is more preferably 4.0 mm or more.

Then, according to the above method for welding austenitic stainless steel sheets, a cooling rate when cooling the back side of a deposited portion 7, which is a site with the highest temperature at the time of welding on the back side of the welded surface 6, from 1200° C. to 900° C. is 110° C./sec or higher, and thus heat generated at the time of welding on the back side of the welded surface 6, where welding defects easily occur, can be promptly transferred to another site. Therefore, the influence due to heat generated at the time of welding, which causes welding defects, can be suppressed and the occurrence of welding defects such as hot cracking and ductility-dip cracking in HAZ (heat-affected zone) can be prevented.

In addition, when the length of an overlap space W when welding the overlapped portion 8 is 2.5 mm or more, the volume of the overlapped portion 8 can be enlarged to promote thermal conduction (heat transfer) and a cooling rate can be raised, and thus the occurrence of welding defects can be effectively prevented. Furthermore, when the length of an overlap space W is 4.0 mm or more, the occurrence of welding defects can be more effectively prevented.

It should be noted that MIG welding is used as arc welding in the above method for welding austenitic stainless steel sheets; however, for example, TIG welding, MAG welding, shielded metal arc welding and the like can be also applied.

In addition, the overlapped portion 8 is subjected to fillet weld in the above method for welding austenitic stainless steel sheets, and welding can be carried out around the middle part of the overlapped portion 8, for example, like a deformed example shown in FIG. 2.

Furthermore, the above method for welding austenitic stainless steel sheets can be applied in both when welding austenitic stainless steel sheets each other and when welding an austenitic stainless steel sheet and another material.

### EXAMPLES

Examples and Comparative Examples will now be described.

Austenitic stainless steel having components shown in Table 1 was melted to obtain a cold-rolled annealed sheet with a sheet thickness of 0.8 mm. In addition, a test piece in the form of sheet of 100×200 mm was cut from each cold-rolled annealed sheet.

TABLE 1

| Steel | | | | | | | | | | | | | | | | | |
|---|---|---|---|---|---|---|---|---|---|---|---|---|---|---|---|---|---|
| type | | | | | | | | | | | | | | | | | |
| No. | C | Si | Mn | P | S | Ni | Cr | N | Ti | Nb | Al | Zr | V | Mo | Cu | B | Category |
| 1 | 0.05 | 2.01 | 0.77 | 0.025 | 0.0008 | 13.1 | 19.3 | 0.04 | | 0.12 | | | | | | | Examples |
| 2 | 0.04 | 2.55 | 0.74 | 0.029 | 0.0007 | 13.9 | 19.5 | 0.03 | | 0.11 | | | | | | | |
| 3 | 0.04 | 3.26 | 0.82 | 0.026 | 0.0008 | 13.3 | 19.2 | 0.03 | | 0.10 | | | | | | | |
| 4 | 0.04 | 3.85 | 1.23 | 0.022 | 0.0005 | 12.9 | 17.8 | 0.04 | | 0.10 | | | | | | | |
| 5 | 0.04 | 3.32 | 0.88 | 0.025 | 0.0009 | 13.4 | 18.8 | 0.04 | 0.15 | | | | | | | | |
| 6 | 0.05 | 3.35 | 1.22 | 0.022 | 0.0009 | 13.9 | 18.5 | 0.04 | | | | 0.23 | | | | | |
| 7 | 0.04 | 3.33 | 0.88 | 0.029 | 0.0008 | 13.5 | 18.8 | 0.04 | | | | | 0.31 | | | | |
| 8 | 0.04 | 3.29 | 0.92 | 0.029 | 0.0008 | 13.4 | 18.5 | 0.04 | | | 0.08 | | | 2.5 | | | |
| 9 | 0.04 | 3.25 | 0.85 | 0.023 | 0.0009 | 13.4 | 18.6 | 0.04 | | | | | | | 2.1 | | |
| 10 | 0.04 | 3.89 | 1.42 | 0.022 | 0.0009 | 13.2 | 17.2 | 0.05 | | | | | | | | 0.003 | |
| 11 | 0.04 | 4.11 | 0.89 | 0.042 | 0.0010 | 15.5 | 16.3 | 0.04 | | 0.11 | | | | | | | Comparative |
| 12 | 0.04 | 4.25 | 0.99 | 0.029 | 0.0010 | 17.2 | 17.1 | 0.04 | | 0.30 | | | | | | | Examples |
| 13 | 0.04 | 3.19 | 0.78 | 0.055 | 0.0029 | 14.2 | 16.9 | 0.04 | | | | | | | | | |
| 14 | 0.04 | 1.39 | 0.67 | 0.083 | 0.0065 | 12.8 | 17.9 | 0.04 | | | | | | | | | |
| 15 | 0.05 | 5.01 | 1.85 | 0.028 | 0.0011 | 16.9 | 18.1 | 0.04 | | 0.10 | | | | | | | |

Two test pieces of each steel type were overlapped and subjected to MIG welding under conditions of a current of 120 A, a voltage of 14.4 V, a core wire 308 (□ 1.2 mm), Ar+5 vol % O₂ as a shielding gas, and a shielding gas flow rate of 10 L/min, and Ar was then directly sprayed as a back-shielding gas to the back side of the welded surface to cool the back side of a deposited portion. The cooling rate was controlled by adjusting the flow rate of the back-shielding gas.

In each steel type, 5 samples were produced and the number of evaluation was 5. One in which cracking occurred on the back side of a deposited portion was evaluated as cracking and the crack occurrence rate was calculated.

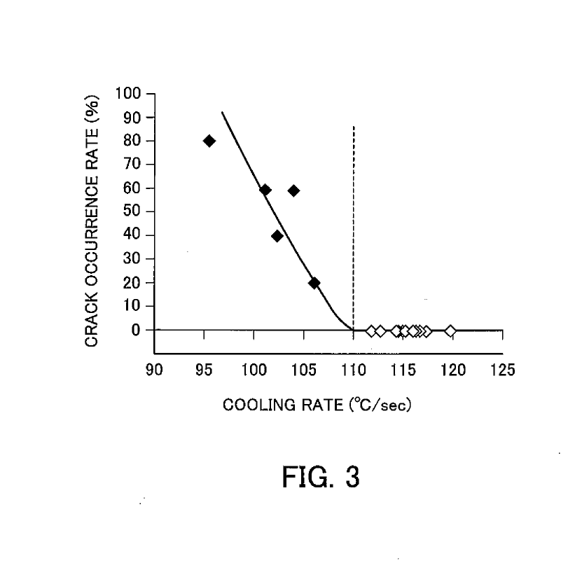

In each steel type, the overlap space, the cooling rate when cooling the back side of a deposited portion from 1200° C. to 900° C. and the crack occurrence rate are shown in Table 2 and a relationship between the cooling rate and the crack occurrence rate is shown in FIG. 3. In FIG. 3, □ shows a case where cracking did not occur and ▪ shows a case where cracking occurred.

TABLE 2

| | Overlap | | Crack | |
|---|---|---|---|---|
| Steel | space | Cooling rate | occurrence rate | |
| type No. | (mm) | (° C./sec) | (%) | Category |
| 1 | 3.0 | 111.5 | 0 | Examples |
| 2 | 3.5 | 112.4 | 0 | |
| 3 | 5.5 | 116.9 | 0 | |
| 4 | 6.0 | 119.5 | 0 | |
| 5 | 4.0 | 114.2 | 0 | |
| 6 | 5.5 | 116.3 | 0 | |
| 7 | 5.0 | 115.9 | 0 | |
| 8 | 4.0 | 113.9 | 0 | |
| 9 | 5.0 | 114.7 | 0 | |
| 10 | 4.5 | 115.6 | 0 | |
| 11 | 2.5 | 102.1 | 40 | Comparative |
| 12 | 1.5 | 95.3 | 80 | Examples |
| 13 | 2.0 | 100.9 | 60 | |
| 14 | 2.5 | 103.8 | 60 | |
| 15 | 3.0 | 105.8 | 20 | |

As shown in Table 2 and FIG. 3, in all Examples, steel type Nos. 1 to 10, in which the cooling rate when cooling the back side of a deposited portion from 1200° C. to 900° C. was 110° C./sec or higher, cracking did not occur on the back side of a deposited portion and weldability was excellent.

On the other hand, in all Comparative Examples, steel type Nos. 11 to 15, in which the cooling rate when cooling the back side of a deposited portion from 1200° C. to 900° C. was less than 110° C./sec, weld cracking occurred and weldability was insufficient.

### INDUSTRIAL APPLICABILITY

The present invention can be used when austenitic stainless steel sheets are overlapped and welded for example in a case where e.g. a dual wall exhaust manifold is produced.

1. A method for welding austenitic stainless steel sheets, the method comprising the steps of:
providing austenitic stainless steel sheets each with a sheet thickness of 0.6 mm to 1.0 mm, which each contain C: 0.08 mass % or less, Si: 1.5 mass % to 4.0 mass %, Mn: 2.0 mass % or less, P: 0.04 mass % or less, S: 0.01 mass % or less, Cr: 16.0 mass % to 22.0 mass %, Ni: 10.0 mass % to 14.0 mass %, and N: 0.08 mass % or less, and contain at least one of Nb and Ti in an amount of 1.0 mass % or less in total, with the rest including Fe and inevitable impurities,
overlapping at least two of the austenitic stainless steel sheets,
welding the overlapping portion by arc welding, and
cooling a back side of a deposited portion, which is a site with the highest temperature at the time of welding on the back side of the welded surface, from 1200° C. to 900° C. at a cooling rate of 110° C./sec or higher.

2. The method for welding austenitic stainless steel sheets according to claim 1, wherein
the austenitic stainless steel sheet contains at least one of Al, Zr and V in an amount of 1.0 mass % or less in total.

3. The method for welding austenitic stainless steel sheets according to claim 1, wherein
the austenitic stainless steel sheet contains at least one of Mo and Cu in an amount of 4.0 mass % or less in total.

4. The method for welding austenitic stainless steel sheets according claim 1, wherein
the austenitic stainless steel sheet contains B in an amount of 0.01 mass % or less.

5. The method for welding austenitic stainless steel sheets according to claim 1, the method further comprising the step of
setting a length of an overlap space to 2.5 mm or more in a weld joint region when welding the overlapped portion.
